(19) United States
(12) Patent Application Publication
(10) Pub. No.: US 2013/0256405 A1
(43) Pub. Date: Oct. 3, 2013

(54) Digital Image Barcode Scanner

(71) Applicant: Mary Ann C. Montout, Vallejo, CA (US)

(72) Inventor: Mary Ann C. Montout, Vallejo, CA (US)

(21) Appl. No.: 13/850,670

(22) Filed: Mar. 26, 2013

Related U.S. Application Data
(60) Provisional application No. 61/685,861, filed on Mar. 27, 2012.

(51) Int. Cl. G06K 7/10

(52) U.S. Cl. CPC G06K 7/10722; G06K 7/10732; G06K 7/10881
USPC 235/375; 235/462.41; 235/462.42

(57) ABSTRACT

A combination barcode scanner and digital imaging device is disclosed. Users pull a trigger button to active the barcode scanner and separately or coincidently activate the digital imaging camera. An integrated touch screen is used to review captured images and barcode data as well as to navigate through various menus and review and set particular settings for the device. Barcode data and/or digital images are stored within the device and can be transferred to a computer via wired or wireless connections. One or more LEDs are used to illuminate subjects, for the barcode scanner, the digital imaging camera, or both.

### CROSS REFERENCE TO RELATED APPLICATIONS

This application claims the benefit of U.S. Provisional Patent App. No. 61/685,861 filed on Mar. 27, 2012, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the invention

This invention relates to the general field of imaging systems, and more specifically toward a combination barcode scanner and digital imaging device. Users pull a trigger button to active the barcode scanner and, upon successful scanning of a barcode, to activate the digital imaging camera. An integrated touch screen is used to review captured images and barcode data as well as to navigate through various menus and review and set particular settings for the device. Barcode data and/or digital images are stored within the device and can be transferred to a computer via wired or wireless connections. One or more LEDs are used to illuminate subjects, for the barcode scanner, the digital imaging camera, or both.

Barcodes are machine-readable figures that represent data associated with the object to which the barcode is attached. Barcode readers scan the barcode and, through the use of decoder circuitry, provide the data representing the barcode to the barcode reader's output port. This data can then be used by a machine, such as a case register or a general-purpose computer.

The medical profession has implemented the use of barcodes in various settings. For example, hospitals give patients bracelets with barcodes printed thereon. Hospital staff scan the barcode on the patient's bracelet to quickly and efficiently identify that patient, whereby the barcode scanner reads the barcode, transmits the decoded data to a computer, and the computer can pull up the patient's electronic file based upon the data received from the barcode scanner.

As can be appreciated by those skilled in the art, barcodes can increase the speed and efficiency at which hospital staff members can identify the patient and review relevant data. However, even if the barcode is accurately scanned and decoded, it does not ensure that the barcode has been secured to the correct patient. These errors are particular harmful to patients that are non-responsive, such as patients that are sleeping, sedated, or in a coma, wherein the patient is not able to identify himself or herself to the staff. Then, if the patient is given medication, it is not recorded in their file, but rather recorded against another patient's record. This can result in over medicating some patients, while under medicating others.

Digital cameras use an image sensor, such as a charge-coupled device (CCD) or complementary metal-oxide-semiconductor (CMOS) sensor chip, to capture an image in electronic format. Images can be quickly captured and transmitted to a computer by using a digital camera. While providing a detailed picture of the subject matter, digital images are not easily parsed by computers to provide identifiable data. Thus, digital images are not as reliable in reading barcodes and producing machine-readable identifiable data, compared to barcode readers.

### SUMMARY OF THE INVENTION

The current invention provides a combination barcode scanner and digital imaging device. Users pull a trigger button to active the barcode scanner and, upon successful scanning of a barcode, to activate the digital imaging camera. An integrated touch screen is used to review captured images and barcode data as well as to navigate through various menus and review and set particular settings for the device. Barcode data and/or digital images are stored within the device and can be transferred to a computer via wired or wireless connections. One or more LEDs are used to illuminate subjects, for the barcode scanner, the digital imaging camera, or both.

It is an object of the invention to provide a device that accurately scans a barcode and takes digital images for generating a digital record and/or confirming the data produced by the scanning of the barcode.

It is another object of the invention to provide a method for quickly identifying a patient and providing a digital image for visual confirmation of that identification.

It is a further object of this invention to provide a system for scanning barcodes to identify a patient, capturing digital images, and associating the digital images with the patient.

In a particular embodiment, there is a device comprising a main body and a pistol grip, where the main body comprises a barcode scanner, a digital camera, a capture image button, and a touch screen, where the pistol grip comprises a scan trigger, wherein depression of the capture image button activates the digital camera, wherein depression of the scan trigger activates the barcode scanner.

In another embodiment, there is a device comprising a main body and a pistol grip, where the main body comprises a barcode scanner, a digital camera, a capture image button, and a touch screen, where the pistol grip comprises a scan trigger, wherein depression of the capture image button activates the digital camera, wherein depression of the scan trigger activates the barcode scanner, wherein the main body further comprises a lens, where the digital camera captures images through the lens, where the lens is scratch resistant tempered glass, wherein the main body further comprises a light emitting diode flash, wherein the light emitting diode flash is activated when the digital camera captures an image, wherein the main body further comprises a scan button, where depression of the scan button activates the barcode scanner, wherein the main body further comprises a camera ready light.

In an additional embodiment, there is a method of treating a patient comprising the steps of: securing a barcode to a patient; scanning the barcode using a digital image barcode scanner; and capturing a digital image using the digital image barcode scanner; where the digital image barcode scanner comprises a main body and a pistol grip, where the main body comprises a barcode scanner, a digital camera, and a touch screen.

In yet another embodiment, there is a method of treating a patient comprising the steps of: securing a barcode to a patient; scanning the barcode using a digital image barcode scanner; capturing a digital image using the digital image barcode scanner; obtaining a reference digital image of the patient using data obtained from the scanned barcode; and confirming that the patient in the reference digital image is the patient secured to the barcode; where the digital image barcode scanner comprises a main body and a pistol grip, where the main body comprises a barcode scanner, a digital camera, and a touch screen.

Another embodiment is a method of documenting patient care comprising the steps of: securing a barcode to a patient; scanning the barcode using a digital image barcode scanner, where the digital image barcode scanner comprises a main body and a pistol grip, where the main body comprises a barcode scanner, a digital camera, and a touch screen; capturing a digital image using the digital image barcode scanner; and sending the digital image to an external device.

An additional embodiment is a method of documenting patient care comprising the steps of: securing a barcode to a patient; scanning the barcode using a digital image barcode scanner, where the digital image barcode scanner comprises a main body and a pistol grip, where the main body comprises a barcode scanner, a digital camera, and a touch screen; capturing a digital image using the digital image barcode scanner; and sending the digital image to an external device; viewing the digital image on the external device; wherein the captured digital image is encoded with data obtained from scanning the barcode, wherein the pistol grip of the digital image barcode scanner comprises a scan trigger, wherein depressing the scan trigger activates the barcode scanner.

In another embodiment, there is a method of documenting patient care comprising the steps of: securing a barcode to a patient; scanning the barcode using a digital image barcode scanner, where the digital image barcode scanner comprises a main body and a pistol grip, where the main body comprises a barcode scanner, a digital camera, and a touch screen; capturing a digital image using the digital image barcode scanner; and sending the digital image to an external device; viewing the digital image on the external device; wherein the captured digital image is encoded with data obtained from scanning the barcode, wherein the pistol grip of the digital image barcode scanner comprises a scan trigger, wherein depressing the scan trigger activates the digital camera.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a top view of a digital image barcode scanner according to selected embodiments of the current disclosure.

FIG. 2 is a front view of a digital image barcode scanner according to selected embodiments of the current disclosure.

FIG. 3 is a side view of a digital image barcode scanner according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

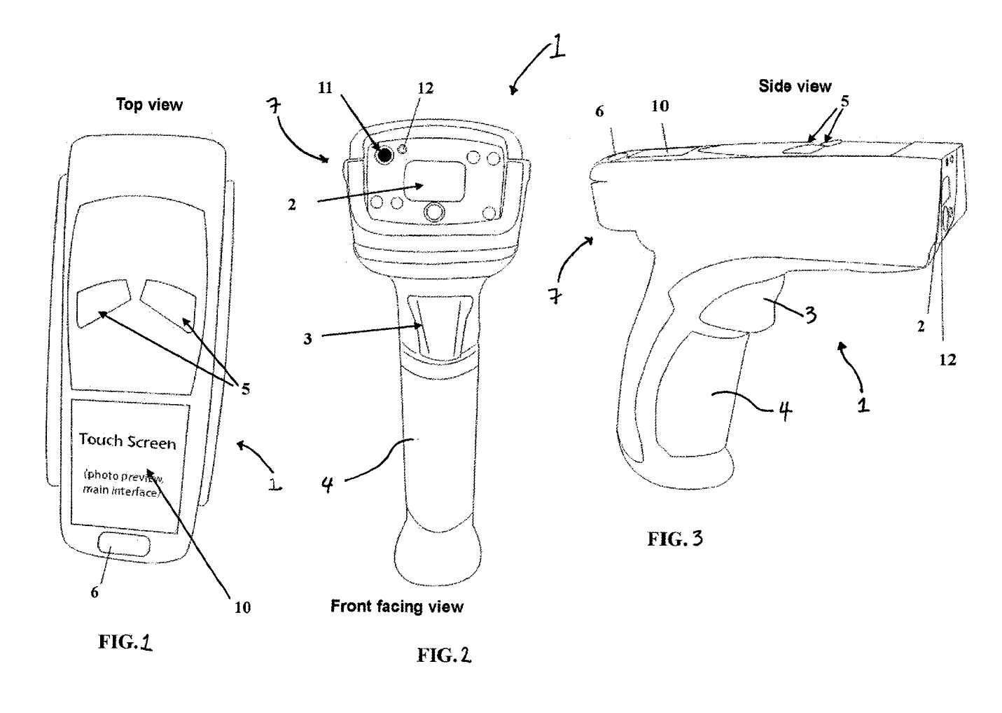

FIG. 1 is a top view of a digital image barcode scanner according to selected embodiments of the current disclosure. The digital image barcode scanner 1 includes a touch screen 10 on its top surface. A capture image button 6 is located below the touch screen 10, while two scan buttons 5 are located above the touch screen 10.

FIG. 2 is a front view of a digital image barcode scanner according to selected embodiments of the current disclosure. The digital image barcode scanner 1 includes a main body 7 and a pistol grip 4. The pistol grip 4 includes a scan trigger 3. The main body has a digital camera located within, whereby the digital camera captures images through a lens 2. An LED flash and camera-ready light 11 are located near the lens 2.

FIG. 3 is a side view of a digital image barcode scanner according to selected embodiments of the current disclosure. The top of the digital image barcode scanner 1 has a capture image button 6 at the back. A touch screen 10 is proximate to the capture image button 6. Two scan buttons 5 are also located on the top of the digital image barcode scanner 1. The lens 2 and LED flash are located at the front of the digital image barcode scanner. 1

The touch screen enables users to interact with the digital image barcode scanner disclosed herein in multiple ways. The screen itself can convey information to the user, such as current settings, current barcode scanned, a preview of the image to be captured, and previous images. Since the screen is touch activated, a user can select icons, settings, or other items on the screen to interact with the digital image barcode device. Examples of more specific interactions are discussed in more detail below.

In a particular embodiment, the touch screen is a menu that enables users to switch between various modes in the device. The menu may contain icons that correspond to a barcode only mode, a scan and digital image capture mode, and a digital image only mode. When in the barcode only mode, the digital image barcode scanner will only scan barcodes and then display the scanned data on the touch screen, transmit it to an external device via wired or wireless data connections, or both. When in the digital image only mode, the digital image barcode scanner acts similar to a digital camera, wherein digital images are captured and displayed on the touch screen, transmitted to an external device via wired or wireless data connections, or both. When in the scan and digital image capture mode, the digital image barcode scanner will both scan barcodes as well as capture digital images. Such a mode can be implemented in multiple ways.

The scan and digital image capture mode allows for the scanning of barcodes and capturing of digital images. In a particular configuration, the user scans a barcode to obtain data, such as a patient ID. Then, the user captures one or more digital images using the internal digital camera. These images are tagged with the data from the scanned barcode. Tagging the image with data can include adding this data to the exchangeable image file format (EXIF) data of the image. Alternatively, tagging the image with data can include adding the scanned data to the filename of the image file. In yet another iteration, the actual image data is modified to include the scanned data, such as by adding a textual representation of the scanned data as a watermark on the image. The images along with the associated scanned barcode data can then be transmitted to an external device, such as a general-purpose computer, via a wired or wireless data connection.

In another configuration, the user scans a barcode to obtain data, such as a patient ID. This data is then transferred to an external device. Then, the user captures one or more digital images using the internal digital camera, which are also transferred the external device. In this fashion, the user may continuously scan barcodes and capture digital images and have that data serially transmitted to an external device.

The digital image barcode scanner captures digital images through its internal digital camera. A user activates one of the capture image buttons located on the surface of the device. In an alternative configuration, a user activates the scan trigger on the pistol grip. This causes the digital camera to capture an image and store it to an internal storage medium, such as non-volatile memory card, or transmit it to an external device, such as a general purpose computer or printer through wired or wireless data connections.

The digital image barcode scanner scans barcodes and stores and/or transmits this data to an external device. The user activates the barcode scanner by depressing a barcode scanning button on the external surface of the device, or by pulling on the scan trigger located on the pistol grip of the device. The data obtained from scanning the barcode can be displayed to the user via the touch screen described above, stored in internal memory within the digital image barcode scanner, and/or transmitted to an external device.

A camera lens is located on the front of the digital image barcode scanner. The internal digital image captures digital images through the camera lens. The camera lens in a particular embodiment is scratch resistant glass that will both protect the internal digital camera as well as resist scratches and other damage to its surface.

Since the digital image barcode scanner may be used in low light, both the barcode scanning function and digital image capture function must operate in dark conditions. In a particular embodiment, the barcode scanner (or barcode reader) uses a laser as a light source and a photodiode to measure the intensity of light reflected back from the barcode. The digital camera includes a light source, such as a light emitting diode (LED), that emits light upon the subject while the digital image is captured. In another particular embodiment, the light source of the digital camera is a xenon tube flash, either integrated within the device or activated therefrom. A camera ready light is also integrated into the front of the device. It emits a softer light and informs the subject that its picture is about to be captured. This camera ready light in a particular embodiment uses an amber colored LED light that emits light and a much lower intensity than the LED light source used when the digital image is captured.

As described above, the digital image barcode scanner transmits data to an external device through a wired or wireless data connection. A wired connection can include a serial or universal serial bus (USB) port, whereby the digital image barcode scanner is connected to another device via a serial or USB cable. In an alternative embodiment, the digital image barcode scanner uses a wireless connection. For example, the digital image barcode scanner will include a wireless internet card that enables it to connect to a network over an 802.11 protocol (also known as Wi-Fi) wireless network, whereby data is transferred between the digital image barcode scanner and an external device using transmission control protocol (TCP).

The digital image barcode scanner may be used by medical professionals to quickly ascertain the identify of a patient while at the same time visually confirming for their records the identity of the patient, physical condition of the patient, and medicines and/or medical devices provided to the patient by using the digital camera of the device.

One particular method may be used to confirm the identity of a patient. It is standard practice in many hospitals to place a bracelet or band around the wrist of a patient that identifies that patient within the hospital (a “hospital band”). The hospital band may include a barcode as well as other identifying characters such as the patient's name. To positively identify the patient, a user obtains a digital image barcode scanner as disclosed herein, and scans the barcode located on the hospital band secured to the patient. The data is then obtained from the barcode and displayed to the user on the touch screen, sent to an external device, or both. Then, the user may capture an image of the hospital band using the capture image button. This captures a digital image of the hospital band itself, thereby confirming the data obtained through the barcode scanner. As with the barcode data, the digital image is displayed to the user on the touch screen, sent to an external device, or both. In this manner, individuals reviewing the record or chart of the patient can see the actual hospital band to confirm the identity of the patient. In another embodiment, a user activates the barcode scanner by depressing the scan trigger and, upon the digital image barcode scanner successfully scanning and decoding the barcode, automatically captures an image of the barcode using the digital camera. In yet another embodiment, the user activates the barcode scanner using a scan button and the digital camera by depressing the scan trigger.

An alternative method of using the digital image barcode scanner disclosed herein confirms the identity of a patient. To positively identify the patient, a user obtains a digital image barcode scanner as disclosed herein, and scans the barcode located on the hospital band secured to the patient. The data is then obtained from the barcode and displayed to the user on the touch screen, sent to an external device, or both. Then, the user may capture an image of the patient's face using the capture image button. This captures a digital image of the patient herself, thereby enabling a separate confirmation of the identity of the patient. As with the barcode data, the digital image is displayed to the user on the touch screen, sent to an external device, or both. The digital image captured of the patient can then be compared to prior captured images to confirm the identity of the patient. In this manner, a reference image of the patient is obtained using the scanned barcode data and is used to confirm that the patient wearing the barcode is in fact the patient assigned to that barcode. This can be done before medications are given to the patient or medical procedures performed on the patient. Alternatively, the comparison and confirmation of the identity of the patient can be done after the fact to audit the care provided to a patient.

A user may also record the physical condition of the patient using the digital image barcode scanner disclosed herein. A user obtains a digital image barcode scanner as disclosed herein, and scans the barcode located on the hospital band secured to a patient. The data is then obtained from the barcode and displayed to the user on the touch screen, sent to an external device, or both. Then, the user captures images of the patient to document her physical condition. For example, the user may capture images of wounds, incision sites, skin color, bruising, portions of or the entire patient's body, or any other visual documentation relevant to that patient. As with the barcode data, the digital image is displayed to the user on the touch screen, sent to an external device, or both. The digital images associated with that particular patient then can be made available to medical professionals either by directly viewing the data on the digital image barcode scanner device, or through their medical chart, either electronically or in hard copy.

Medications and/or medical items provided to a patient may be tracked using the digital imager barcode scanner disclosed herein. A user obtains a digital image barcode scanner as disclosed herein, and scans the barcode located on the hospital band secured to a patient. The data is then obtained from the barcode and displayed to the user on the touch screen, sent to an external device, or both. Then, the user captures images of the medications and/or medical devices provided to the patient. For example, the user may capture images of pills that are about to be consumed by a patient, the vial of medicine and volume in the syringe that is administered to the patient, the cool compress applied to a patient and its positioning on the patient, or any other medications or medical related items given to that patient. As with the barcode data, the digital image is displayed to the user on the touch screen, sent to an external device, or both. The digital images associated with medications or medical related items given to that patient are then available for other medical professionals to review, such as to confirm or audit the care provided to that particular patient.

Alternatively, the medications and/or medical items may have a barcode located on their surface, and so they too may be scanned by the barcode scanner. A user obtains a digital image barcode scanner as disclosed herein, and scans the barcode located on the hospital band secured to a patient. The data is then obtained from the barcode and displayed to the user on the touch screen, sent to an external device, or both. Then, the user scans the barcodes of the medications and/or medical devices provided to the patient. For example, the user may scan the barcode of pills that are about to be consumed by a patient, the vial of medicine and volume in the syringe that is administered to the patient, or any other medications or medical related items given to that patient. As with the barcode data of the hospital band, the barcode data of the medications and/or medical devices is displayed to the user on the touch screen, sent to an external device, or both. Then, the user captures images of the medications and/or medical devices provided to the patient. For example, the user may capture images of pills that are about to be consumed by a patient, the vial of medicine and volume in the syringe that is administered to the patient, the cool compress applied to a patient and its positioning on the patient, or any other medications or medical related items given to that patient. As with the barcode data, the digital image is displayed to the user on the touch screen, sent to an external device, or both. The digital images associated with medications or medical related items given to that patient are then available for other medical professionals to review, such as to confirm or audit the care provided to that particular patient. The digital images associated with medications or medical related items given to that patient are then available for other medical professionals to review, such as to confirm or audit the care provided to that particular patient.

In a particular embodiment, the digital camera of the digital image barcode scanner captures still images as well as video, with our without sound. Such a feature is particularly helpful when documenting the status of a patient. Breathing rates, mannerisms, twitches, seizures, and other medically relevant information that occurs over a period of time may be captured using video, where still images would not have quite the same value.

When connected to an external device or network, via a wired or wireless connection, the digital image barcode scanner may obtain data related to a barcode scanned by the device. A user obtains a digital image barcode scanner as disclosed herein, and scans the barcode located on the hospital band secured to a patient. The digital image barcode scanner then makes a request for additional data related to the data obtained from the scanned barcode. For example, the digital image barcode scanner may make a request over a TCP/IP network to an application programming interface (API), where the API returns the patient data associated with the scanned barcode. Then, the patient's information is displayed on the touch screen of the digital image barcode scanner. This could include medications that should be administered to the patient. The patient's information could also include requests for visual documentation, whereby the user can then capture digital images using the digital image barcodes canner. The digital image is displayed to the user on the touch screen, sent to an external device, or both. When sending the image to an external device, the digital image barcode scanner may send the image over a TCP/IP network, with the patient's ID obtained from the scanned barcode, to an API or other electronic interface to update the client's electronic record. A medical professional or other individual may then view the digital image on an external device.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

That which is claimed:

1. A device comprising
a main body and a pistol grip,
where the main body comprises a barcode scanner, a digital camera, a capture image button, and a touch screen,
where the pistol grip comprises a scan trigger,
wherein depression of the capture image button activates the digital camera,
wherein depression of the scan trigger activates the barcode scanner.

2. The device of claim 1, wherein the main body further comprises a lens, where the digital camera captures images through the lens.

3. The device of claim 2, where the lens is scratch resistant tempered glass.

4. The device of claim 1, wherein the main body further comprises a light emitting diode flash, wherein the light emitting diode flash is activated when the digital camera captures an image.

5. The device of claim 1, wherein the main body further comprises a scan button, where depression of the scan button activates the barcode scanner.

6. The device of claim 1, wherein the main body further comprises a camera ready light.

7. A method of treating a patient comprising the steps of:
securing a barcode to a patient;
scanning the barcode using a digital image barcode scanner; and
capturing a digital image using the digital image barcode scanner;
where the digital image barcode scanner comprises a main body and a pistol grip, where the main body comprises a barcode scanner, a digital camera, and a touch screen.

8. The method of claim 7, wherein the digital image includes the barcode that was scanned.

9. The method of claim 7, wherein the digital image includes the face of the patient.

10. The method of claim 7, further comprising the steps of:
obtaining a reference digital image of the patient using data obtained from the scanned barcode; and
confirming that the patient in the reference digital image is the patient secured to the barcode.

11. The method of claim 7, wherein the digital image includes medication that will be provided to the patient.

12. A method of documenting patient care comprising the steps of:
securing a barcode to a patient;
scanning the barcode using a digital image barcode scanner, where the digital image barcode scanner comprises a main body and a pistol grip, where the main body comprises a barcode scanner, a digital camera, and a touch screen;
capturing a digital image using the digital image barcode scanner; and
sending the digital image to an external device.

13. The method of claim 12, wherein the captured digital image is encoded with data obtained from scanning the barcode.

14. The method of claim 12, wherein the digital image includes the patient's face.

15. The method of claim 12, wherein the digital image includes medications to be given to the patient.

16. The method of claim 12, wherein the digital image includes a medical device to be given to the patient.

17. The method of claim 12, wherein the digital image includes a portion of the patient's body.

18. The method of claim 12, further comprising the step of:
viewing the digital image on the external device.

19. The method of claim 12, wherein the pistol grip of the digital image barcode scanner comprises a scan trigger, wherein depressing the scan trigger activates the barcode scanner.

20. The method of claim 12, wherein the pistol grip of the digital image barcode scanner comprises a scan trigger, wherein depressing the scan trigger activates the digital camera.
